(19) United States
(12) Patent Application Publication
(10) Pub. No.: US 2002/0071718 A1
(43) Pub. Date: Jun. 13, 2002

(54) Retainer clip

(76) Inventors: Garry Marty, Fishers, IN (US); Darrell Scott Crowe, Lebanon, IN (US)

Correspondence Address: Masco Corporation, 21001 Van Born Road, Taylor, MI, 48180, US

(21) Appl. No.: 09/981,091

(22) Filed: Oct. 17, 2001

Related U.S. Application Data
(60) Provisional application No. 60/241,074, filed on Oct. 17, 2000.

(51) Int. Cl. F16B 7/00; F16B 12/36; F16B 13/00

(52) U.S. Cl. 403/293

(57) ABSTRACT

A retaining clip for attaching together two conduits comprising a spine member having a first end and a second end, a first set of pincer arms extending from the first end of the spine member, and a second set of pincer arms extending from the second end of the spine member. Once the first conduit is inserted within the second conduit, the first set of pincer arms attaches to the first conduit, and the second set of pincer arms attaches to the second conduit, thereby preventing the first conduit from separating from the second conduit. The retaining clip may be removed to separate the two conduits.

### RELATED APPLICATIONS

This application claims priority from U.S. Provisional Application No. 60/241,074 filed on Oct. 17, 2000.

### FIELD OF THE INVENTION

The present invention relates to a retainer clip for holding two generally cylindrical articles such as hoses together.

### BACKGROUND OF THE INVENTION

Connecting two conduits, such as water pipes or lines, together, especially in a restricted space such as under a sink, is a rather awkward and involved process. It normally requires a clamp or swivel nut, which must be tightened by the installer. This involves the installer getting under the sink, using both hands, and utilizing tools such as a screwdriver or wrench. It would be very advantageous if two conduits, such as water hoses, could be connected rather easily and without the use of tools. The present invention provides a retainer clip for connecting two conduits such as hoses, which can be easily and readily installed without the use of tools or screws.

### SUMMARY OF THE INVENTION

The present invention provides a retainer clip for connecting two conduits such as water pipes. The retainer clip can be quickly and easily assembled and disassembled with and from the conduits. The retainer clip contains two longitudinally spaced apart clip portions, each clip portion having a pair of flexible legs. The retainer clip is forced over two joined conduits such as water hoses. Once over the hoses the two pairs of legs spring back toward each other clasping the hoses between them. One clip portion is secured to one of the hoses while the other clip portion is secured to the other hose.

### BRIEF DESCRIPTION OF THE DRAWINGS

FIG. 1 is a perspective view of the retainer clip of the present invention and two hoses which the retainer clip connects, the retainer clip and the hoses are in the unassembled or unconnected position;

FIG. 2 is a perspective view of the retainer clip;

FIG. 3 is a perspective view of the retainer clip of the present invention and two hoses which the retainer clip connects, the retainer clip and the hoses are in the assembled or connected position;

FIG. 4 is a cross sectional view taken along lines 4-4 in FIG. 3;

FIG. 5 is a left side elevational view of the retainer clip;

FIG. 6 is a cross sectional view taken along lines 6-6 in FIG. 5;

FIG. 7 is a cross sectional view taken along lines 7-7 in FIG. 5;

FIG. 8 is a top plan view of the retainer clip;

FIG. 9 is a front elevational view of the retainer clip; and

FIG. 10 is a longitudinal sectional view of the retainer clip, connecting both pieces of hose together.

### DESCRIPTION OF THE PREFERRED EMBODIMENT

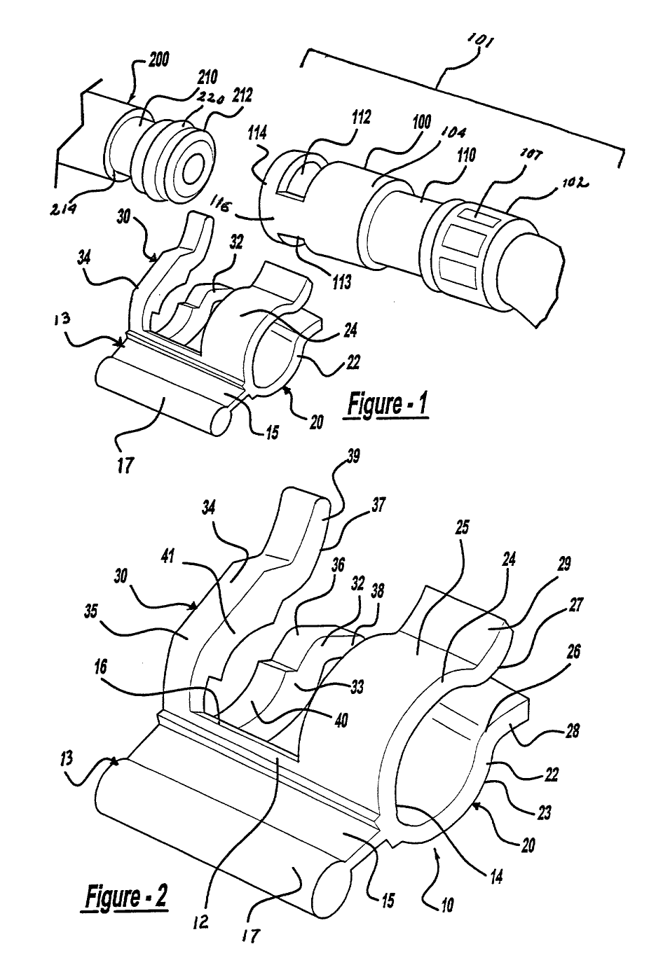

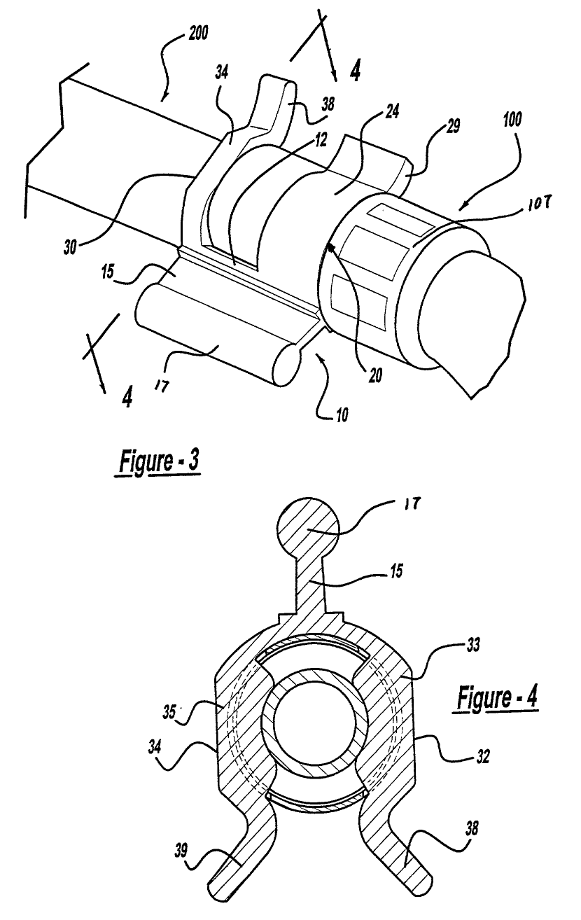

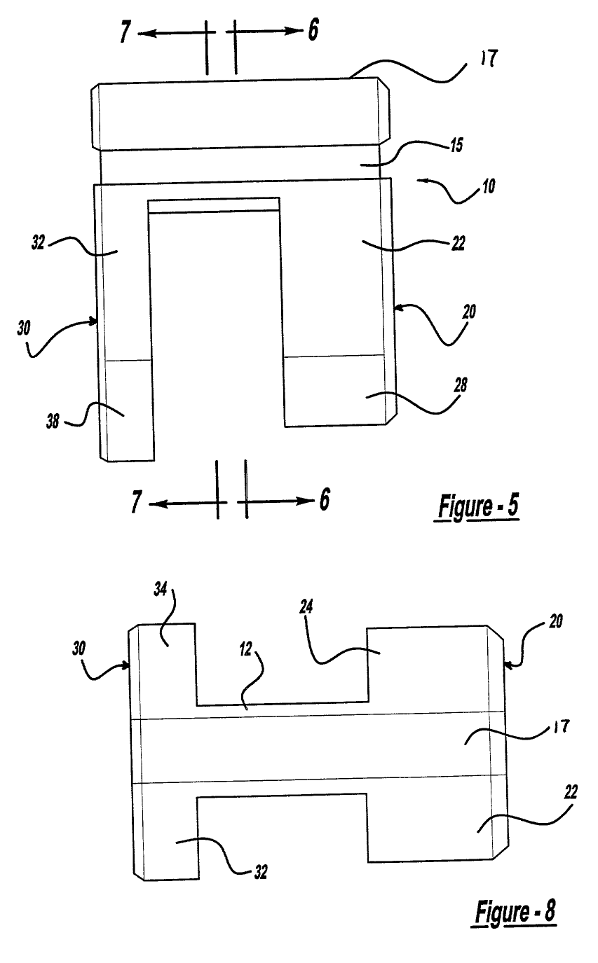

The retainer clip of the present invention is indicated in the figures by reference numeral 10. Referring to FIG. 1, retaining clip 10 is used to connect securely a first fluid conduit 100 with a second fluid conduit 200. The first fluid conduit 100 includes a distal attachment portion 101 for receiving the retaining clip 10. The distal attachment portion 101 comprises a proximal hose section 102, a groove section 110, the groove section 110 being distal to the proximal hose section 102, a middle hose section 104, distal to the groove section 110, and a distal hose section 114. The distal hose section 114 is connected with the middle hose section 104 via bridge sections 116. In between the bridge sections 116 and the middle and distal hose sections, 104 and 114, respectively, are slots 112, 113. The groove section 110 has a smaller diameter than the middle hose section 104.

In an alternative embodiment, the distal attachment portion 101 may be separate from the first fluid connector 100, and may be attached to the first fluid conduit 100 for the purpose of receiving the retainer clip 10. In such an embodiment, this distal attachment portion 101 may be clamped to the first fluid conduit 100 via a clamp 107, or attached by some other means. As shown in FIG. 1, a clamp 107 may still be used to add additional strength to the distal portion of fluid conduit 100.

Also shown in FIG. 1 is the second fluid conduit 200. Second fluid conduit 200 comprises a nipple portion 212, for attachment inside the first fluid conduit 100, an annular notch portion 213, for receiving an O-ring 220, and an annular groove section 210, the annular groove section 210 being distal to the notch portion 213.

Referring to FIGS. 1 and 2, retainer clip 10 is a one-piece member preferably made, such as by molding, of a resilient material such as high strength plastic. Retainer clip 10 includes two clip portions 20 and 30, which are longitudinally spaced apart from each other along member 12. Clip portion 20 includes a pair of spaced legs 22, 24 formed integrally at their upper ends with longitudinally extending, arcuate-shaped member 12. Clip portion 30 includes a pair of spaced legs 32, 34 formed integrally at one end with member 12. Legs 22, 24 extend from a first inner concave surface 14 of arcuate-shaped member 12. Legs 32, 34 extend from a second inner concave surface 16 of member 12. Legs 22, 24 and 32, 34 are flexible and can be separated or pulled apart and spring back together to their original position as shown in FIGS. 1 and 2 upon release of the prying apart force.

As shown in FIG. 2, a gripping portion 13, which can be grasped or held by the hand, extends from the top of member 12. Grip portion 14 is comprised of a generally flat, rectangular-shaped member 15 extending from, and formed integrally with, arcuate-shaped member 12. At the top of rectangular-shaped member 15 is a cylindrical spine member 17, which extends along the length of rectangular-shaped member 15 and is formed integrally therewith.

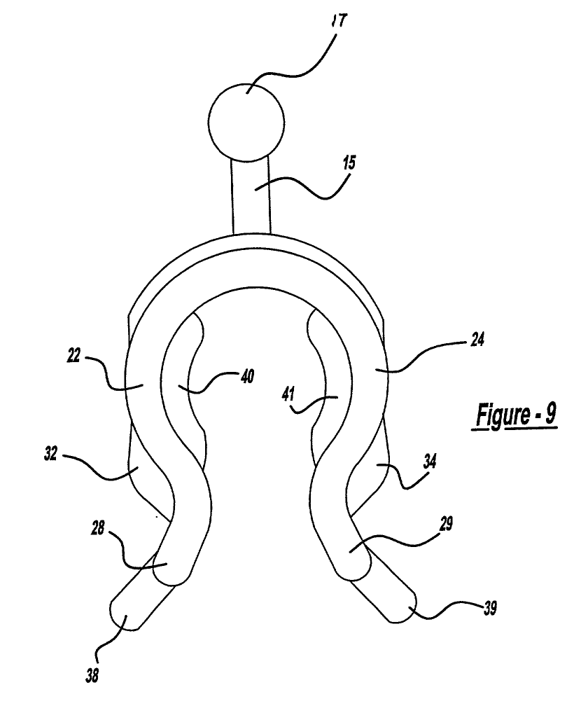

The clip portion 20 is wider in diameter than clip portion 30. That is to say legs 22 and 24 are wider apart than legs 32 and 34. As best illustrated in FIGS. 2 and 7, legs 22 and 24 have upper portions 23 and 25 that are bowed out, with the interiors thereof being concave and forming a generally smooth, partially circular shape. The bottom sections 28, 29 of legs 22, 24 flare outwardly and diverge from each other. Rounded elbows 26, 27 are formed at the junction of the bottom sections 28, 29 of the legs with the upper sections 23, 25 of legs 22, 24.

This construction of the clip portion 20 allows easy mounting and retention of clip portion 20 in groove 110 of first fluid conduit 100 (FIG. 1).

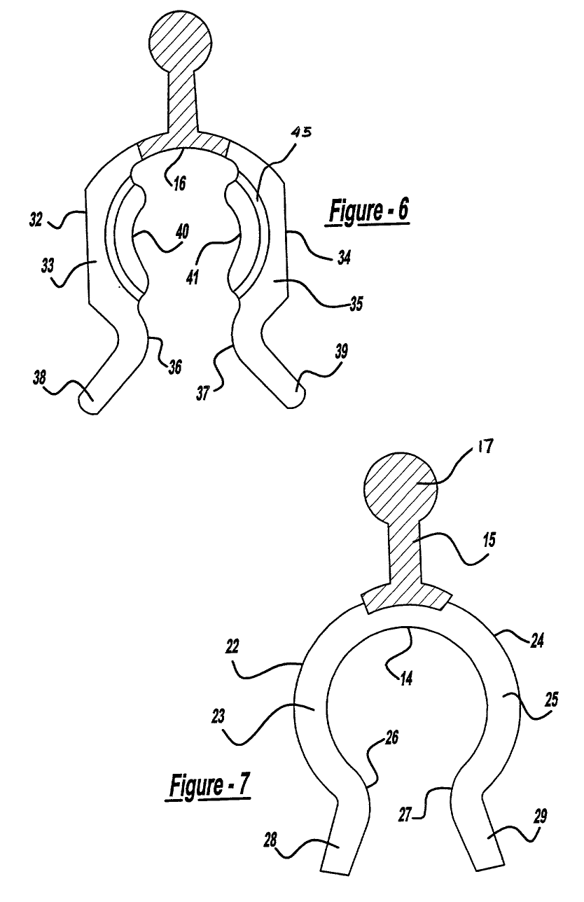

Clip portion 30 includes a pair of spaced apart legs 32, 34. As best illustrated in FIGS. 2 and 6 legs 32 and 34 have upper portions 33, 35 and lower portions 38, 39. Upper portions 33, 35 of legs 32, 34 are generally parallel. The bottom sections 38, 39 of legs 32, 34 flare outwardly and diverge from each other. Rounded elbows 36, 37 are formed at the junction of the bottom sections 38, 39 of the legs with the upper sections 33, 35 of legs 32, 34.

The inner portions of the upper sections 33, 35 have inwardly extending raised portions 40, 41. These raised portions 40, 41 extend through slots 112, 113 in first fluid conduit 100 and engage groove 210 in second fluid conduit 200, thereby securely connecting second fluid conduit 200 to first fluid conduit 100 when the retainer clip 10 is mounted thereon.

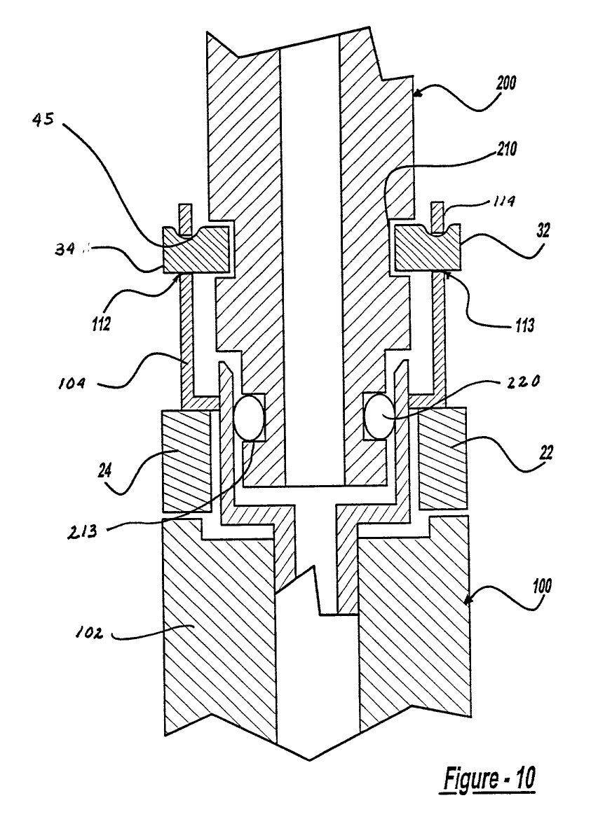

In a preferred embodiment of the invention, and as shown in FIG. 10, the upper portions 33, 35 of legs 32, 34 contain partially semi-circular grooves 45. As will be described in further detail below, these semi-circular groove 45 help secure the retainer clip 10 in place once the retainer clip 10 is attached to the fluid conduits 100, 200.

In order to attach the retainer clip 10, the second fluid conduit 200 is inserted into the distal attachment portion 101 of first fluid conduit 100. The retainer clip 10 is held at gripping portion 13 and pressed onto the distal attachment portion 101. The legs 22, 24 and 32, 34 of retainer clip 10, being resilient or flexible, are forced apart when elbows 26, 27 36, 37 come into contact with groove 110 and end section 114 of conduit 100. The legs then snap back together after the elbows pass over conduit 100 and prevent the retainer clip from being withdrawn. The clip portion 20 functions as the anchor for the retainer clip 10, while clip portion 30 functions to lock second fluid conduit 200 in first fluid conduit 100.

To use the retaining clip the retaining clip legs 22, 24 assemble onto the cylindrical diameter of the groove 110 while legs 32, 34 engage with slots 112, 113. The raised portions 40, 41 (or smaller inner diameter sections) of legs 32, 34 extend into slots 112, 113 and engage groove 210. An O-ring 220 seals off the connected hoses 100 and 200. As fluid conduits 100, 200 are subjected to pressure, they have the tendency to pull apart from each other, thereby forcing legs 32, 34 apart. This pulling apart tendency is resisted by the resiliency in legs 32, 34, and the fact that legs 32, 34 are contained within groove 210 of second fluid conduit 200. In addition, end section 114 of first fluid conduit 100 rests within grooves 45, further preventing legs 32, 34 from moving outwards.

The above describes the present invention by means of the best mode contemplated by the invention at the time of filing the application. It would be clear to one skilled in the art that variations and modifications of the present invention are possible without departing from the spirit and scope of the invention, as defined in the appended claims.

I claim:

1. A retaining clip for attaching together a first and a second conduit comprising:
a spine member having a first end and a second end, a first set of pincer arms extending from the first end of the spine member;
a second set of pincer arms extending from the second end of the spine member; such that when the first conduit is inserted within the second conduit, the first set of pincer arms attaches to the first conduit, and the second set of pincer arms attaches to the second conduit, thereby preventing the first conduit from separating from the second conduit.

2. The retaining clip as defined in claim 1, wherein the spine member, the first set of pincer arms, and the second set of pincer arms are molded as a single piece from a resilient, high strength plastic material.

3. The retaining clip as defined in claim 2, wherein the spine member comprises a cylindrical grasping section, a flat section, and an arcuate-shaped member from which the pincer arms extend.

4. The retaining clip as defined in claim 3, wherein the first set of pincer arms extend outward from the spine member in a substantially cylindrical pattern.

5. The retaining clip as defined in claim 3, wherein the second set of pincer arms have an attaching end that attaches to the spine member, a middle section, and an end section, and wherein the middle section of each arm is substantially parallel to each other.

6. The retaining clip as defined in claim 5, wherein the middle section of each arm of the second set of pincer arms has an inwardly extending tab portion for attachment within a groove portion along the second conduit.

7. The retaining clip as defined in claim 6, wherein the first and second set of pincer arms are detachable from the first and second conduits, thereby allowing the first conduit to separate from the second conduit.
